(19) United States
(12) Patent Application Publication
(10) Pub. No.: US 2007/0247840 A1
(43) Pub. Date: Oct. 25, 2007

(54) Compact emergency illumination unit

(76) Inventor: Byung Il Ham, Rancho Pales Verdes, CA (US)

Correspondence Address: Walter T. Kim, Suite 1300, 2030 Main Street, Irvine, CA, 92614, US

(21) Appl. No.: 11/408,641

(22) Filed: Apr. 21, 2006

(51) Int. Cl. B60Q 1/26

(52) U.S. Cl. 362/227

(57) ABSTRACT

A compact illumination unit is configured provide illumination during a utility power failure. The compact illumination unit includes a housing structure, a battery supported within a battery compartment of the housing structure, a conductive base coupled to the housing structure and a number of light elements supported by the housing structure. The illumination unit further includes a circuit assembly coupled between the light elements and the conductive base to supply power to the light elements using power received from an external power source via the conductive base. The circuit assembly is further configured to supply power to the light elements using power received from the battery during a utility power failure.

### BACKGROUND OF THE INVENTION

1. Field of the Invention

The present invention generally relates to illumination devices, and in particular, to compact emergency illumination devices.

2. Description of the Related Art

Certain buildings are required by building codes to provide emergency lighting, such as exit signs with emergency lighting capability. One purpose of the emergency lighting is to help people safely exit the building in a time of a utility power failure and other emergency situations. There are a number of disadvantages associated with conventional emergency lighting devices which employ one or more incandescent lamps and a large battery pack to power the incandescent lamps during a power failure. Such emergency lighting units often require mounting of a special mounting mechanism to the wall or ceiling of a building to support the weight of the large and heavy battery pack. Consequently, such emergency lighting units are cumbersome to install and inconvenient to maintain and utilize.

### BRIEF SUMMARY OF EMBODIMENTS THE INVENTION

Described herein are various embodiments of an illumination unit capable of providing illumination during a power failure. The illumination unit generally comprises a housing structure, a battery supported within a battery compartment of the housing structure, a conductive base coupled to the housing structure and a number of light elements supported by the housing structure. The illumination unit further includes a circuit assembly coupled between the light elements and the conductive base to supply power to the light elements using power received from an external power source via the conductive base. The circuit assembly is further coupled between the light elements and the battery to supply power to the light elements using power received from the battery during a utility power failure.

In one aspect of one embodiment, the light elements utilized by the illumination unit comprise light-emitting diodes (LEDs) mounted to a first circuit board. And the circuit assembly is formed, partially or entirely, on a second circuit board. In one embodiment, the first circuit board supporting the LEDs and the second circuit board supporting the circuit assembly are arranged in a parallel relationship with respect to each other. In another embodiment, the first circuit board supporting the LEDs and the second circuit board supporting the circuit assembly are arranged in a perpendicular relationship with respect to each other. The embodiments of the present invention take advantage of relatively small amount of space required by LEDs and the circuits controlling the LEDs and arrange them in such a way that backup emergency battery power can be contained with the compact illumination unit.

In another aspect of one embodiment, the battery compartment formed inside the housing structure includes conductive elements coupled to the circuit assembly and positioned to establish electrical contact with positive and negative terminals of the battery supported therein. The circuit assembly is capable of receiving DC power from the battery contained in the battery compartment and using the received DC power to supply power to the light elements during a power failure of the external power source. The circuit assembly is further configured to receive AC electrical power via the conductive base and convert the received power into power suitable for illuminating the light elements.

In a further aspect of one embodiment, the circuit assembly controlling operations of the illumination unit comprises a battery charging circuit to recharge the battery supported in the battery compartment, a power failure detecting circuit to detect a power failure of the external power source, and a power control circuit to automatically switch a source of power for illuminating the light elements from the external power source to the battery contained in the battery compartment when a power failure is detected by the power failure detecting circuit.

In another characterization of one embodiment, a compact emergency illumination unit comprises a housing structure, a conductive base attached to the housing structure; a plurality of light elements supported by the housing structure, a battery compartment formed inside the housing structure between the light elements and the conductive base, and a circuit assembly supported by the housing structure. One of the functionalities of the circuit assembly is to receive AC electrical power via the conductive base and convert the received AC power into power suitable for illuminating the light elements. Another functionality of the circuit assembly is to receive AC electrical power via the conductive base and convert the received power into power suitable for charging the battery supported by the battery compartment. Yet another functionality of the circuit assembly is to receive DC electrical power from the battery supported within the battery compartment and convert the received DC power into power suitable for illuminating the light elements.

In one aspect of a preferred embodiment, the emergency illumination unit is configured in size comparable to that of conventional incandescent lamps and/or conventional compact fluorescent lamps. By doing so, the emergency illumination unit can be conveniently installed in any suitable ceiling lamp sockets, hanging type lamp sockets and/or lamp sockets of lamp fixtures. In a preferred embodiment, the emergency illumination unit is sized and shaped in a compact lamp configuration with an overall height of the housing structure combined with the conductive base being less than 150 mm and an outer diameter of the housing structure being less than 80 mm.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 is an elevational view, partly in cross-section, of a compact emergency illumination unit according to one embodiment of the invention.

FIG. 2 is a cross-sectional top plan view of the compact emergency illumination unit of FIG. 1 taken along line A-A.

FIG. 3 is an elevational view, partly in cross-section, of a compact emergency illumination unit according to another embodiment of the invention.

FIG. 4 is a cross-sectional top plan view of the compact emergency illumination unit of FIG. 3 taken along line B-B.

FIG. 5 is a block diagram of a compact emergency illumination unit according to one embodiment of the invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known hardware components, structures and techniques have not been shown in detail in order to avoid obscuring embodiments of the present invention. It should be noted that, as used in the description herein and the claims, the meaning of “in” includes “in” and “on”.

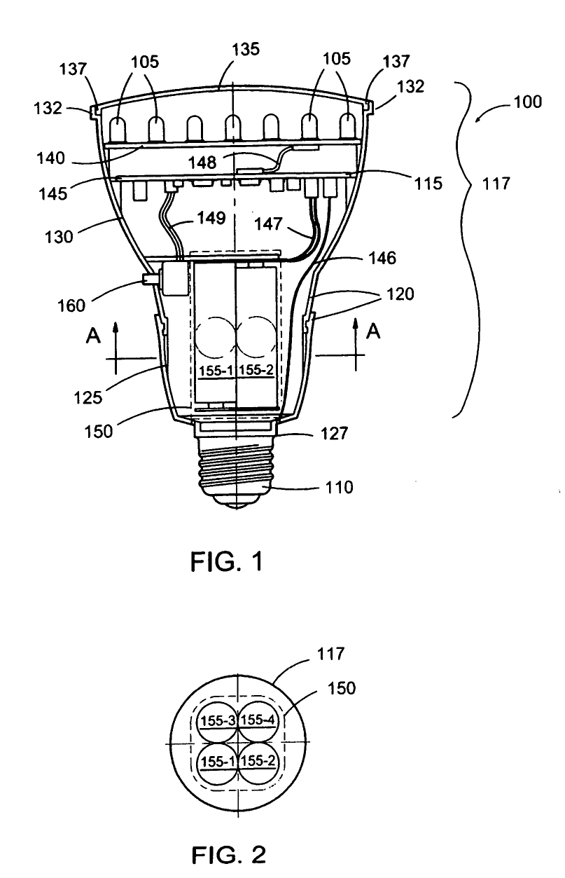

FIGS. 1 and 2 depict a compact emergency illumination unit 100 according to one embodiment of the invention. The illumination unit 100 generally includes a number of light elements 105, a conductive base 10 and a circuit assembly 115 coupled between the light elements 105 and the conductive base 10. The illumination unit 100 further includes a housing assembly 117 to contain the light elements 105 and the circuit assembly 115. The illustrated housing assembly 117 generally comprises a lamp body member 120 and a cover member 135 attached to the lamp body member 120. The illustrated lamp body member 120 comprises at least two separate pieces; a lower casing member 125 and an upper casing member 130. The lower casing member 125 includes a neck section 127 to which the conductive bas 110 is non-detachably attached. The cover member 135 is preferably transparent and mounted to the top of the upper casing member 130 for covering the light elements 105. The cover member 135 has a flange 137 along the peripheral edge thereof to mate with an annular step 132 formed on the upper casing member 130.

The conductive base 110 is preferably adapted for connection to an AC power supply output socket (e.g., lamp socket) to receive input AC electrical power (e.g., 120 volt AC power). In one embodiment, the conductive base 110 is a screw-in type base which includes threads for threadedly engaging with an electrical lamp socket. The conductive base 110 includes at least two contact terminals positioned on the base so as to establish contact with the contacts of the lamp socket when the conductive base is received in the lamp socket. In one embodiment, the conductive base 110 attached to the illumination unit is a standard Edison-type screw-in conductive base having a 34/32 inch medium screw base to screw into a standard Edison-type lamp socket. In an alternative embodiment, the conductive base 110 attached to the illumination unit is a 21/32 inch intermediate screw base.

In one embodiment, the light elements 105 comprise light-emitting diodes (LEDs) mounted on an upper surface of a first circuit board 140 (also referred herein as “LED mounted circuit board” or “LED circuit board). The LEDs employed by the illumination device 100 may be any suitable type of semiconductor diode that emits light when voltage is applied thereto. It is understood that any suitable technique may be used to mount the LEDs to the first circuit board 140, including soldering, pins and matrix of balls. The first circuit board 140 is positioned near the cover member 135 to emit light through the cover member. In the illustrated embodiment, seven rows of LEDs are shown; however any number of LEDs can be used. It should be noted that while in the illustrated embodiment, the LEDs are mounted on a relatively flat circuit board, a curved circuit board may be employed to hold the LEDs so that light emitted thereby can be irradiated in more than one direction.

In accordance with one aspect of one embodiment, a battery compartment 150 is formed inside the housing assembly 117 between the conductive base 110 and the LED mounted circuit board 140. The battery compartment 150 is configured to support at least one battery. In the illustrated embodiment, the battery compartment 150 is configured to support four AA or AAA type batteries 155-1 through 155-4. It is understood that the present invention is not dependent on the type and number of battery used, and thus the present invention can be implemented with different type and number of battery. Each battery 155 has respective positive and negative terminals. The battery compartment 150 is provided with conductive plate elements positioned to establish electrical contact with the positive and negative terminals of the batteries supported therein. The housing assembly 117 is provided with an opening for insertion and removal of batteries 155 into and from the battery compartment 150. Preferably, rechargeable batteries 155 are used with the illumination unit 100.

The light elements 105 (e.g., LEDs) can be powered from either the external power source (e.g., 120 volt AC power) received via the conductive base 110 or can be powered by DC electrical power received from the rechargeable batteries 155 contained in the illumination unit 100. The circuit assembly 115 is responsible for switching a source of power for illuminating the light elements between the external power source and the internal battery power source. At least a portion of the circuit assembly 115 is formed on a second circuit board 145 (also referred herein as “circuit assembly printed circuit board” or “circuit assembly PCB”). The circuit assembly PCB 145 is electrically connected between the electrical contacts of the first circuit board 140 and the contact terminals of the conductive base 110 via electric wires 148 and 146, respectively. The circuit assembly PCB 145 is further connected to the batteries 155 supported by the battery compartment 150. More specifically, when the rechargeable batteries 155 are placed in the battery compartment 150, the conductive terminals of the rechargeable batteries establish contact with conductive plate elements provided in the battery compartment. The conductive plate elements are coupled to the circuit assembly PCB 145 via electrical wires 147 for establishing electrically contact between the batteries 155 and the circuit assembly PCB 145.

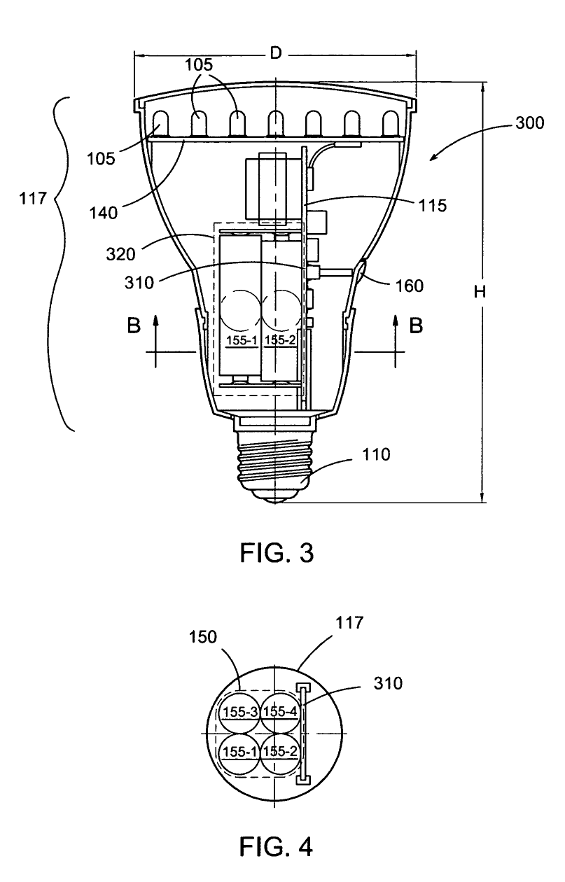

It should be noted that any suitable mechanism can be used to securely mount the LED circuit board 140 and the circuit assembly PCB 145 to the interior of the housing assembly 117. For example, the circuit boards 140, 145 can be held in place within the housing assembly 117 using mounting brackets, snap mechanisms, rivets, screws, and adhesives. In one embodiment, the LED circuit board 140 and the circuit assembly PCB 145 are arranged in a parallel relationship with respect to each other, as shown in FIGS. 1 and 2. In another embodiment, the LED circuit board 140 and the circuit assembly PCB 145 are arranged in a perpendicular relationship with respect to each other, as shown in FIGS. 3 and 4. While in the illustrated embodiments, the LED circuit board 140 and the circuit assembly PCB 145 are provided on separate circuit boards, it should be noted that the light elements (e.g., LEDs) and components of the circuit assembly, partially or entirely, can be combined into a single circuit board.

The illumination unit 100 preferably includes a switch 160 to enable a user to manually control certain operations of the illumination unit. The switch 160 protrudes from the upper casing member 130 of the housing assembly 117 via a corresponding switch hole. In one embodiment, the switch 160 is a three-way switch having three switch positions. In one implementation, when the three-way switch 160 is switched to the first position, the illumination unit 100 is configured remain turned on during both the power failure periods (i.e., when external power source is not available) and the power recovered periods (i.e., when external power source is available). When the three-way switch 160 is switched to the second position, the illumination unit 100 is configured to turn on only during the power failure periods and remain turned off during power recovered periods. When the three-way switch is switched to the third position, the illumination is configured to remain turned off regardless of the status of the external power source. Accordingly, the three-way switch 160 may be operated so that the illumination unit 100 operates only in response to detection of a power failure of the external power source. In an alternative embodiment, the switch 160 is a manual on-off switch to enable a user to manually turn the illumination on and off. In particular, the manual on-off switch may be used to manually disconnect the battery power supply from the rechargeable batteries 155 to the light elements 105 to conserve battery power in the event illumination is not needed during a power failure.

The illumination unit 100 may be employed anywhere inside or outside of a building to provide illumination. In one particular use, the illumination unit 100 may be used to provide emergency lighting when utility power to a building is discontinued, for example, due to a failure of utility power. In this regard, the illumination unit 100 may be installed near the doorways and/or hallways to supply illumination in a time of a power failure to assist people in exiting the building.

During normal operations (i.e., when AC utility power is available), the illumination unit 100 installed in a lamp socket receives electrical power (e.g., 120 volts AC) via the conductive base 110, which is converted by the circuit assembly 115 into power suitable for illuminating the LEDs. The electrical power received via the conductive base is also used by the circuit assembly 115 to charge the rechargeable batteries 115. In one embodiment, the circuit assembly 115 is capable of detecting a power failure of the external power source (e.g., 120 volt AC utility power). The circuit assembly 115 may further be capable of detecting a power recovery wherein the utility power returns back to its normal electrical power level. The circuit assembly 115 is configured, in one embodiment, the switch source of power for illuminating the LEDs between the external power source and the internal battery power source based on the status of the utility power coupled to the illumination unit. More specifically, when a power failure is detected, the circuit assembly 115 is configured to keep the LEDs 105 illuminated during a power failure situation by automatically switching from the external power source to the battery power source. After which, when a power recovery is detected, the circuit assembly 115 is configured, in one embodiment, to automatically switch back to the external power source to illuminate the LEDs 105.

Depicted in FIGS. 3 and 4 is a compact emergency illumination unit 300 according to another embodiment of the invention. The components shown in FIGS. 3 and 4 which are identical to the components shown in FIGS. 1 and 2 are designated by the same reference numerals. As such, the illumination unit 300 generally comprises a housing assembly 117 to contain a number of light elements (LEDs), a conductive base 110 and a circuit assembly 115 coupled between the light elements 105 and the conductive base 10. The circuit assembly 115, partially or entirely, is formed on a printed circuit board 310 (also referred herein as “circuit assembly PCB”). As seen by referring to FIG. 3, the embodiment of the illumination unit has the circuit assembly PCB 310 arranged in a perpendicular relationship with respect to the LED circuit board 140. More specifically, the circuit assembly PCB 310 is mounted inside the housing assembly 117 in a vertical orientation between the LED circuit board 140 and the conductive base 110, adjacent to the battery compartment 320.

It will be appreciated that because the LEDs 104 employed by the illumination unit 100, 300 consume significantly less electrical power than conventional incandescent lamps, the illumination unit is capable of providing emergency illumination for a longer period of time during power failure from the same amount of battery power contained therein. It will further be appreciated that because small sized batteries such as AA or AAA can provide sufficient power to illuminate the LEDs 105, a sufficiently sized battery compartment for supporting the required batteries can be formed within the compact lamp housing structure 117 as illustrated in FIGS. 1 and 2. In accordance with one aspect of one embodiment, the illumination unit 100, 300 is configured in size and shape comparable to that of conventional incandescent lamps and/or conventional compact fluorescent lamps. In accordance with another aspect of one embodiment, the illumination unit 100, 300 is configured to fit into a ceiling lamp socket, a hanging type lamp socket and/or a lamp socket of a lamp fixture. Dimensions of embodiments of the compact emergency illumination unit 100, 300 are described with reference to FIG. 3. The overall height H of embodiments of the illumination unit 100, 300, including the screw-in base, is preferably less than 150 mm and more preferably in the range from 100 mm to 140 mm. The outer diameter D of embodiments of the illumination unit 100, 300 is preferably less than 80 mm, and more preferably in the range from 40 mm to 75 mm.

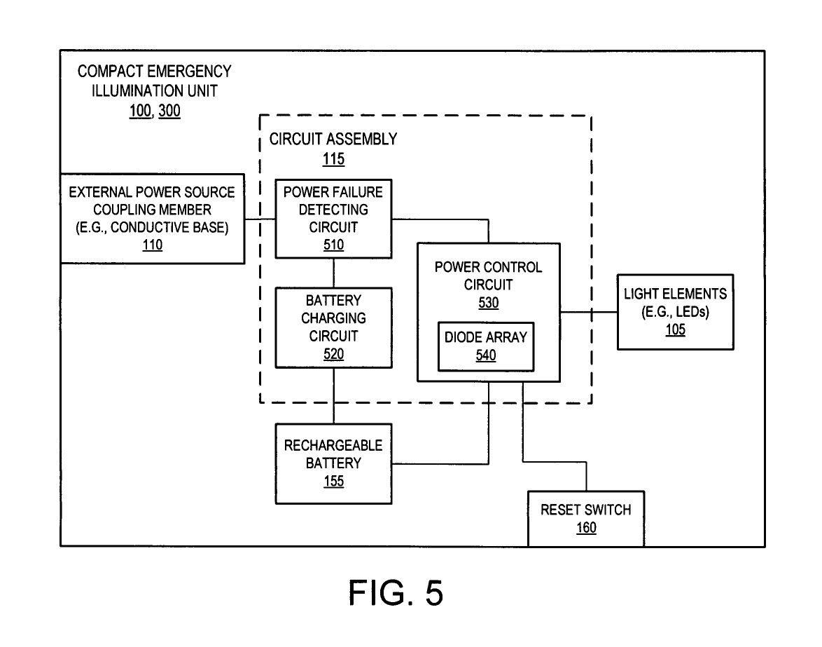

FIG. 5 depicts a block diagram of a compact emergency illumination unit 100, 300 according to embodiments of the invention. The illumination unit 100, 300 generally comprises light elements (e.g., LEDs) 105, external power source coupling member (e.g., conductive base) 110, rechargeable battery 155 and circuit assembly 115 coupled to control operations of the illumination unit. In one embodiment, the circuit assembly 115 comprises a number of functional elements including, power failure detection circuit 510, battery charging circuit 520 and power control circuit 530. The power failure detection circuit 510 is responsible for detecting a power failure of the external power source (e.g., 120 volt AC utility power received via the conductive base 110).

As noted above, the external power source coupling member 110, in one embodiment, is a screw-in type conductive base for removably coupling to a lamp socket to receive electrical power from an external source (e.g., 120 volt AC utility power). The power control circuit 530 is configured to convert power received from the external power source (e.g., 120 volt AC power) into power suitable for energizing the LEDs 105. In one embodiment, the power control circuit 530 includes diode array 540 for providing proper electrical voltage and current to illuminate the LEDs 105.

In accordance with one aspect of one embodiment, the circuit assembly 115 includes the functionality to automatically switch between the external power source and the internal battery power source to power the LEDs 105. In one embodiment, this functionality is carried out by the power control circuit 530. The power control circuit 530 is responsible for maintaining the LEDs 105 illuminated by controlling a source of power for illuminating the LEDs 105 between the external power source and the internal battery power source. The power control circuit 530 is configured to automatically switch the source of power supplying the LEDs 105 from the external power source to the internal power source when a failure of the external power source is detected by the power failure detecting circuit 510. More specifically, the DC power supplied from the rechargeable battery 155 is used by the power control circuit 530 to illuminate the LEDs 105. When a power recovery is detected, the power control circuit 530 is configured to cause the LEDs 105 to be powered from the external power source.

The battery charging circuit 520 is coupled between the conductive base 110 and the rechargeable battery 155. The battery charging circuit 520 is configured to receive power from external power source (e.g., 120 volts AC) and convert the received power into power suitable for charging the rechargeable batteries 155 supported by the battery compartment of the illumination unit 100, 300. The battery charging circuit 520 may include transformer and voltage regulator to control the voltage value range to ensure that the voltage does not overload the battery 155 to be charged.

The illumination unit 100, 300 may further include a reset switch 160 coupled to the power control circuit 530 to enable a user to control the operations thereof. In one embodiment, the switch 160 is a three-way switch having three switch positions. When the three-way switch is switched to the first position, the illumination unit is configured remain turned on during power failure periods (e.g., when external power source is not available) and power recovered periods (e.g., when external power source is available). When the three-way switch is switched to the second position, the illumination unit is configured to turn on during power failure periods but remain turned off during power recovered periods. When the three-way switch is switched to the third position, the illumination is configured to remain turned off. In another embodiment, the switch 160 is a manual on-off switch to enable a user to manually turn the illumination unit on and off. The switch 160 can be used to conserve its battery life by manually turning the illumination unit off when the illumination unit is powered by the battery.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. An illumination unit comprising:
a plurality of light elements;
a coupling member to removably couple to an external power source;
a circuit assembly coupled between the light elements and coupling member to supply electrical power to the light elements; and
a housing structure to support the circuit assembly and the light elements, the housing structure including a battery compartment to contain at least one battery, the battery compartment including conductive elements positioned to electrically contact with positive and negative terminals of the at least one battery supported therein, the conductive elements of the battery compartment coupled to the circuit assembly.

2. The illumination unit of claim 1, wherein the light elements comprise light-emitting diodes (LEDs).

3. The illumination unit of claim 1, wherein the circuit assembly is capable of supplying electrical power from the battery contained in the battery compartment to the light elements during a power failure of the external power source.

4. The illumination unit of claim 1, wherein the coupling member comprises a screw-type conductive base attached to the housing structure to mate with a lamp socket.

5. The illumination unit of claim 2, wherein the LEDs are mounted to a first circuit board and the circuit assembly comprises a second circuit board.

6. The illumination unit of claim 5, wherein the first circuit board and the second circuit board are arranged in a parallel relationship with respect to each other within the housing structure.

7. The illumination unit of claim 5, wherein the first circuit board and the second circuit board are arranged in a perpendicular relationship with respect to each other.

8. The illumination unit of claim 1, wherein the circuit assembly comprises:
a battery charging circuit to recharge the at least one battery supported in the battery compartment;
a power failure detecting circuit to detect a power failure of the external power source; and
a power control circuit coupled to the power failure detector to switch a source of power for illuminating the light elements from the external power source to the battery contained in the battery compartment when a power failure is detected.

9. The compact illumination unit of claim 4, wherein the housing structure comprises:
a lamp body member having a neck section to which the screw-type conductive base is non-detachably attached, the lamp body member including an opening for receiving the at least one battery; and
a cover member attached to the lamp body member to cover the light elements.

10. The compact illumination unit of claim 1, further comprising a switch coupled to the circuit assembly to enable a user to manually turn off the illumination unit.

11. An LED illumination unit comprising:
a plurality of light-emitting diodes (LEDs);
a conductive base;
a battery;
a circuit assembly coupled between the conductive base, the battery and the LEDs; and
a housing coupled to the conductive base, the housing to contain the LEDs, the circuit assembly and the battery.

12. The LED illumination unit of claim 11, wherein the housing includes a battery compartment to support the battery.

13. The LED illumination unit of claim 12, wherein the circuit assembly comprises a circuit board coupled to conductive elements positioned in the battery compartment to electrically contact the battery contained therein.

14. The LED illumination unit of claim 11, wherein the LEDs are capable of receiving electrical power from an external power source via the conductive base.

15. The LED illumination unit of claim 14, wherein the LEDs are capable of receiving electrical power from the battery during a power failure of the external power source.

16. The LED illumination unit of claim 15, wherein the circuit assembly is capable of recharging the rechargeable battery via electrical power received from the external power source.

17. The LED illumination unit of claim 11, wherein the conductive base comprises a screw-type base.

18. A compact emergency illumination unit comprising:
a housing structure;
a conductive base attached to the housing structure;
a plurality of light elements supported by the housing structure;
a battery compartment formed inside the housing structure between the light elements and the conductive base, the battery compartment including conductive elements positioned to electrically contact with positive and negative terminals of a battery supported therein; and
a circuit assembly supported by the housing structure, the circuit assembly coupled to receive AC electrical power via the conductive base and capable of converting the received AC power into power suitable for illuminating the light elements, the circuit assembly coupled between the conductive base and the conductive elements of the battery compartment to receive AC electrical power via the conductive base and capable of converting the received power into power suitable for charging the battery supported by the battery compartment, and the circuit assembly coupled between conductive elements of the battery compartment and the light element assembly to receive DC electrical power from the battery supported by the battery compartment and capable of converting the received DC power into power suitable for illuminating the light elements.

19. The compact emergency illumination unit of claim 18, wherein an overall height of the housing structure combined with the conductive base is less than 150 mm.

20. The compact emergency illumination unit of claim 18, wherein an outer diameter of the housing structure is less than 80 mm.

21. The compact emergency illumination unit of claim 18, further comprising:
a switch coupled to the circuit assembly, the switch operable to disconnect power supply from the battery supported by the battery compartment to the light elements.

22. The compact emergency illumination unit of claim 18, further comprising:
a switch coupled to the circuit assembly, the switch operable to enable the light elements to be illuminated during a power failure by automatically switching to the battery supported by the battery compartment to supply power to the light elements when the power failure is detected.

23. The compact emergency illumination unit of claim 18, further comprising:
a switch coupled to the circuit assembly, the switch operable to enable the light elements to be illuminated only in response to detection of a power failure of power supply received via the conductive base.

24. The compact emergency illumination unit of claim 18, wherein the light elements comprise light-emitting diodes (LEDs).
